(19) United States
(12) Patent Application Publication
(10) Pub. No.: US 2005/0196324 A1
(43) Pub. Date: Sep. 8, 2005

(54) Fluid harmonic scanner

(76) Inventors: Martin Russell Harris, Windsor (AU); John David Allen, Essendon (AU)

Correspondence Address: STITES & HARBISON PLLC, 1199 NORTH FAIRFAX STREET, SUITE 900, ALEXANDRIA, VA, 22314, US

(21) Appl. No.: 11/069,044

(22) Filed: Mar. 2, 2005

(30) Foreign Application Priority Data
Mar. 2, 2004 (AU) 2004901059

(51) Int. Cl. G01N 21/64

(52) U.S. Cl. 422/82.07

(57) ABSTRACT

A scanning mechanism for an optical probe having an optical head and an optical transmitter for transmitting light from a light source to the optical head, the scanning mechanism comprising a resilient member coupled to the optical transmitter, a fluid supply for providing a fluid to the head, and an exit path for the fluid from the head that has a fluid entry. The resilient member is located at the fluid entry so that fluid flow into the fluid entry passes over a portion of the resilient member and creates a pressure difference across the resilient member such that the resilient member is urged into the fluid entry thereby reducing the fluid flow and reducing the pressure difference, whereby the resilient member and therefore the fiber can be induced to oscillate.

### RELATED APPLICATION

This application is based on and claims the benefit of the filing date of AU patent application no. 2004901059 filed 2 Mar. 2004, the contents of which are incorporated herein by reference in its entirety.

### FIELD OF THE INVENTION

The present invention relates to a scanner for driving, principally but not exclusively, an optical fiber in a probe such as an endoscope, microscope, endomicroscope or optical coherence tomograph, including confocal versions of these.

### BACKGROUND OF THE INVENTION

One existing scanning mechanism for endoscopes employs a miniature tuning fork. Another existing scanning mechanism comprises a combination of mirrors, while still another comprises a piezoelectric drive. However, in some applications (such as for within a nuclear magnetic resonance imaging machine) it may be desirable to prove a scanning mechanism of non-metallic components.

### SUMMARY OF THE INVENTION

In a first broad aspect, therefore, the present invention provides a scanning mechanism for an optical probe having an optical head and an optical transmitter for transmitting light from a light source to said optical head, the scanning mechanism comprising:
a resilient member coupled to said optical transmitter;
a fluid supply for providing a fluid to said head; and
an exit path for said fluid from said head having a fluid entry;
wherein said resilient member is located at said fluid entry so that fluid flow into said fluid entry passes over a portion of said resilient member and creates a pressure difference across said resilient member such that said resilient member is urged into said fluid entry thereby reducing said fluid flow and reducing said pressure difference, whereby said resilient member and therefore said fiber can be induced to oscillate.

In one embodiment, the exit path comprises a conduit.

In one embodiment, the fluid supply comprises a further conduit. In another embodiment the fluid supply comprises a fluid reservoir.

The fluid may be air.

In a second broad aspect, the present invention provides a scanning mechanism for an optical probe having an optical head and an optical transmitter for transmitting light from a light source to said optical head, the scanning mechanism comprising:
an inflatable reservoir coupled to said optical transmitter;
a fluid supply for providing a fluid to said reservoir; and
means for expelling said fluid from said reservoir;
wherein said reservoir is alternately inflated and deflated so that said optical transmitter is reciprocated.

It will be understood that the reservoir may be only partially inflated and deflated.

Preferably the means for expelling said fluid from said reservoir comprises said fluid supply when operated in reverse.

Alternatively, the means for expelling said fluid comprises a spring for compressing an exterior surface of said reservoir.

Alternatively, the means for expelling said fluid comprises a resilient material surrounding or constituting said reservoir.

In a third broad aspect, the present invention provides a scanning mechanism for an optical probe having an optical head and an optical transmitter for transmitting light from a light source to said optical head, the scanning mechanism comprising:
a resilient member coupled to said optical transmitter; and
an actuator for providing pressure waves, coupled to said resilient member;
whereby said resilient member can be vibrated by said actuator so as to vibrate said optical transmitter.

In one embodiment, the scanning mechanism further includes a conduit coupled to said actuator for transmitting said pressure waves to said resilient member.

In a fourth broad aspect, the present invention provides a scanning mechanism for an optical probe having an optical head and an optical transmitter for transmitting light from a light source to said optical head, the scanning mechanism comprising:
a resilient member coupled to said optical transmitter;
a fluid supply for providing a fluid to said head and having a fluid exit; and
an exit path for said fluid to exit said head;
wherein said resilient member is located at said fluid exit so that fluid flow out of said fluid exit passes over a portion of said resilient member and creates a pressure difference across said resilient member such that said resilient member is urged into said fluid exit thereby impeding said fluid flow and reducing said pressure difference, whereby said resilient member and therefore said fiber can be induced to oscillate.

In one embodiment, the fluid supply comprises a conduit.

Preferably in each of the above-described aspects that employ a resilient member, the member is adapted or operable to oscillate at a resonant frequency.

### BRIEF DESCRIPTION OF THE DRAWING

In order that the invention may be more clearly ascertained, embodiments will now be described, by way of example, with reference to the accompanying drawings, in which:

FIG. 1A is a schematic view of a fiber confocal probe with scanning mechanism according to an embodiment of the present invention;

FIG. 1B is a further schematic view of the fiber confocal probe of FIG. 1A;

FIG. 2 is a schematic view of a detail of the scanning mechanism of a fiber confocal probe according to a further embodiment of the present invention;

FIG. 3 is a schematic view of a fiber confocal probe with acoustic scanning mechanism according to another embodiment of the present invention;

FIG. 4 is a schematic view of a positional feedback mechanism for the devices of FIGS. 1A to 3 according to the present invention;

FIG. 5 is a schematic view of an alternative positional feedback mechanism for the devices of FIGS. 1A to 3 according to the present invention;

FIG. 6 is a schematic view of an alternative reciprocating mechanism according to the present invention for the device of FIG. 1B;

FIG. 7 is a schematic view of still another alternative reciprocating mechanism according to the present invention for the device of FIG. 1B; and

FIG. 8 is a schematic view of a flexible sack and conduit of the reciprocating mechanism of FIG. 7 or of FIG. 8.

### DETAILED DESCRIPTION

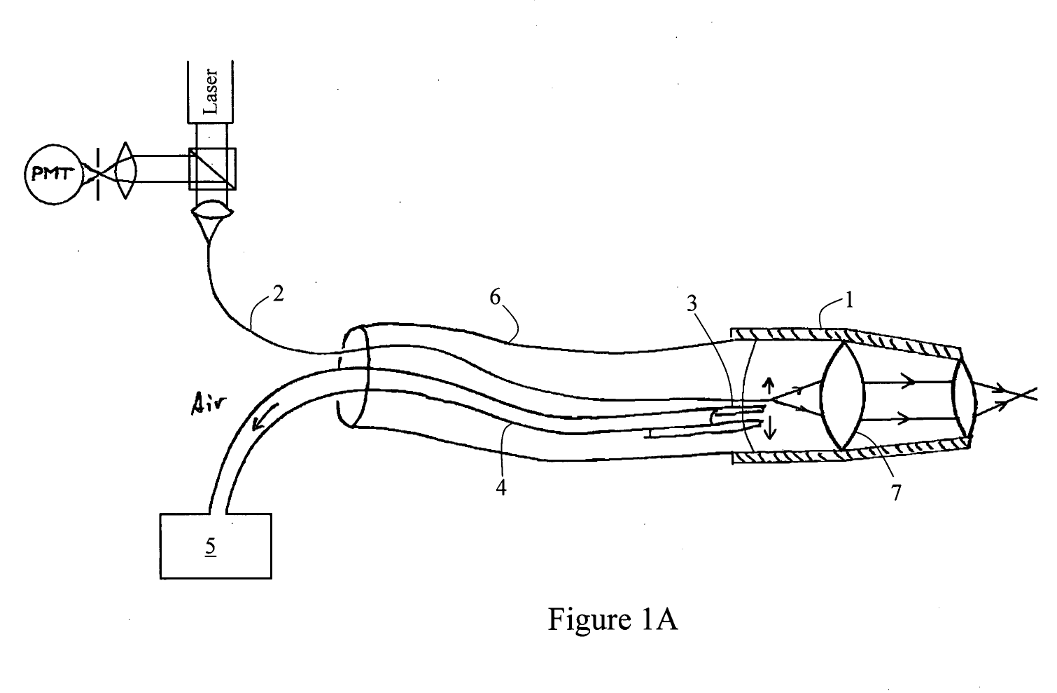

FIG. 1A is a schematic, simplified view of a fiber confocal probe with a glass lens assembly, held together with ceramic, polymer or other non-conductive material 1.

In this view, certain elements have been omitted for the sake of clarify, but are described below by reference to FIG. 1B.

The scanning mechanism is provided as follows.

An optical transmitter in the form of an optical fiber 2 is glued onto the side of a non-conductive resilient reed 3. The reed is positioned at the end (in fact the fluid entry end) of a thin flexible polymer tube 4 so that air drawn into and along the tube flows past one side of the reed. A pump 5 continuously draws air up the tube. The tube 4 and the fiber 2 are enclosed within another larger tube or jacket 6, which has the dual functions of protecting the fiber 2 and inner tube 4 and also allowing air to flow down to replace the air being sucked out by the inner tube 4. The jacket 6—or equivalently the atmosphere outside the jacket—acts as an air supply. The tube 4 thus acts as an exit path for air in the jacket 6. The air flowing past one side of the reed 3 (that is, the lower side of the reed 3 in the view of FIG. 1A) causes a reduction in pressure, owing to the Bernoulli effect. The now excess air pressure on the other (upper in FIG. 1A) side of the reed causes the reed to bend towards the air flow and hence to somewhat obstruct the flow of air into the tube 4. This leads to the equalization of the air pressure across the reed, which is thus able to spring back to its former, equilibrium position. This allows the air flow to be restored to its former level (or, if the flexing of the reed has fully occluded the opening of the tube 4, to recommence) and the cycle is repeated causing the reed to vibrate or oscillate.

This vibration provides the mechanical movement which is required for the fast scan of the attached fiber 2 in front of the collimating lens 7.

FIG. 1B is a schematic, isometric view of the same tip. The distal end of the tube 11 and the reed 12 are attached to an arm 13 which is pivoted at a point 14 by a resilient leaf spring 15. The bending axis of the pivot is at right angles to the vibrational axis of the reed.

Between the pivot arm and the jacket wall of the probe is a fluid reservoir in the form of a small flexible polymer sack 16. This sack is connected to another flexible polymer tube or pipe 17 which runs inside the jacket 6 to the exterior at the proximal end of the assembly. There it is joined to a mechanical pump 18 which pumps fluid 19 (liquid or gas) along the pipe 17 to the sack 16. This inflates the sack 16 and urges the reed 12, and therefore an optical fiber carried by the reed 12, at right angles to the vibration of the reed described above or vertically in the view of FIG. 1B.

When the pump reverses its action the leaf spring 15 pushes the sack 16 causing the fluid to travel back along the pipe 17, allowing the reed 12 and fiber to return to their original positions.

Thus, both X and Y scanning motions can be imparted to the reed and hence the attached fiber.

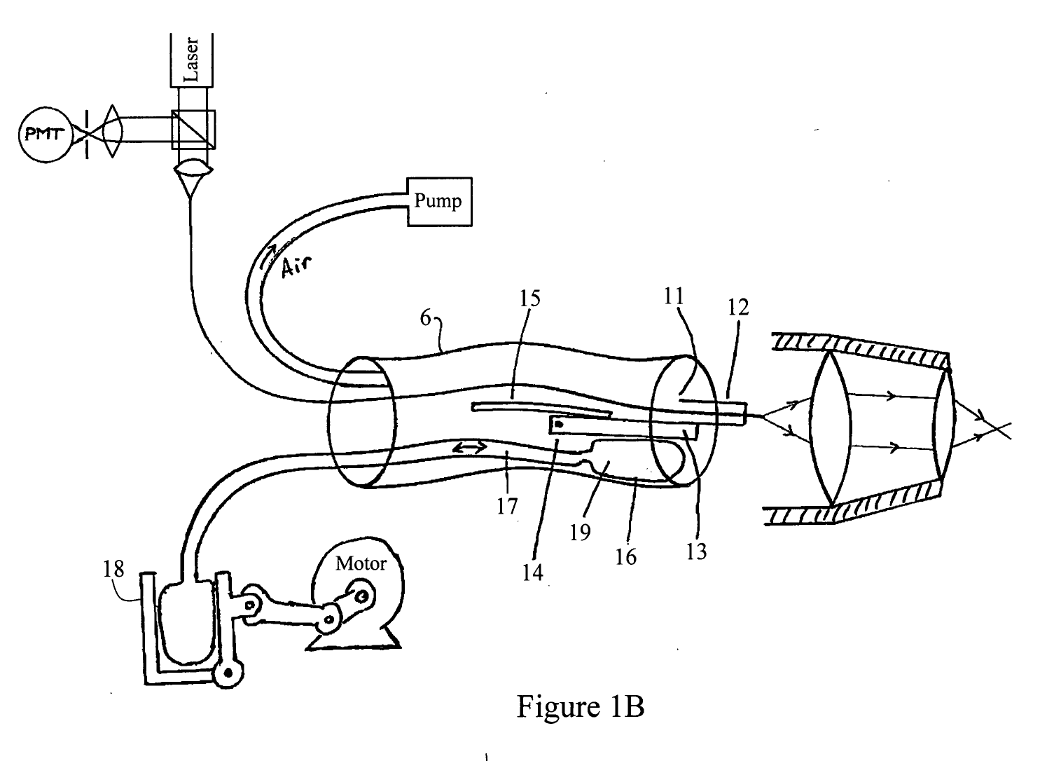

FIG. 2 is a schematic view of a detail of a further embodiment, comparable otherwise to that of FIGS. 1A and 1B, but involving two reeds. It may be desirable in some applications to position two separate reeds 21 and 22 at the end of the pipe 24 opposite one another so that they are both caused to vibrate by the passage of air up the pipe. One reed 21 carries an optic fiber 23, while the second reed 22 acts as a counter-weight to balance the inertial reaction forces and minimize tissue damping.

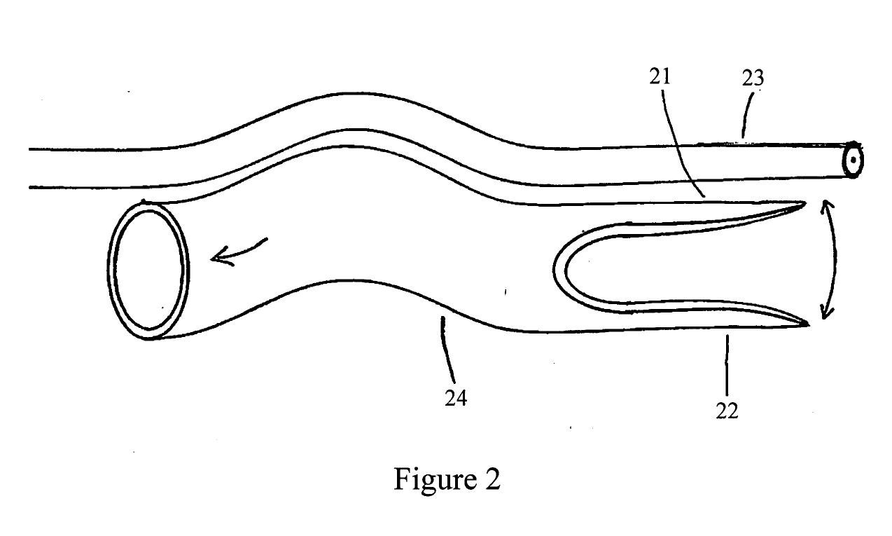

FIG. 3 is a schematic view of a fiber confocal probe with a scanning mechanism according to another embodiment of the present invention. The scanning mechanism includes an actuator in the form of audio speaker 30 driven by an audio oscillator 31, and is configured to feed pressure pulses (in this example, sound waves) into a tube 32 and down to a reed 33. The reed carries an optical fiber 34 for transmitting excitation and return light. The tube 32, reed 33 and optical fiber 34 are enclosed in a jacket 35. The probe includes a glass lens assembly 36. For clarity, the glass lens assembly 36 is shown decoupled from the jacket 35.

In use, the pulses drive the reed 33 and hence the optical fiber 34 to mechanically oscillate. Other actuators may also be used. A feedback mechanism, described below, is used to ensure that the speaker is operated at the right frequency and phase.

Optical Pulse Operation.

It is known that sound may be generated by directing pulsed light into an absorbing medium in a resonant cavity. It is envisaged that, in a further embodiment, the reed could be vibrated by means of laser pulses passed down an optical fiber to an absorber close to the reed.

Positional Feedback.

In these embodiments, positional feedback is required, particularly for the fast scan, in order to synchronize image acquisition and also to ensure the correct phase for the drive mechanisms in the embodiments of FIGS. 2 and 3.

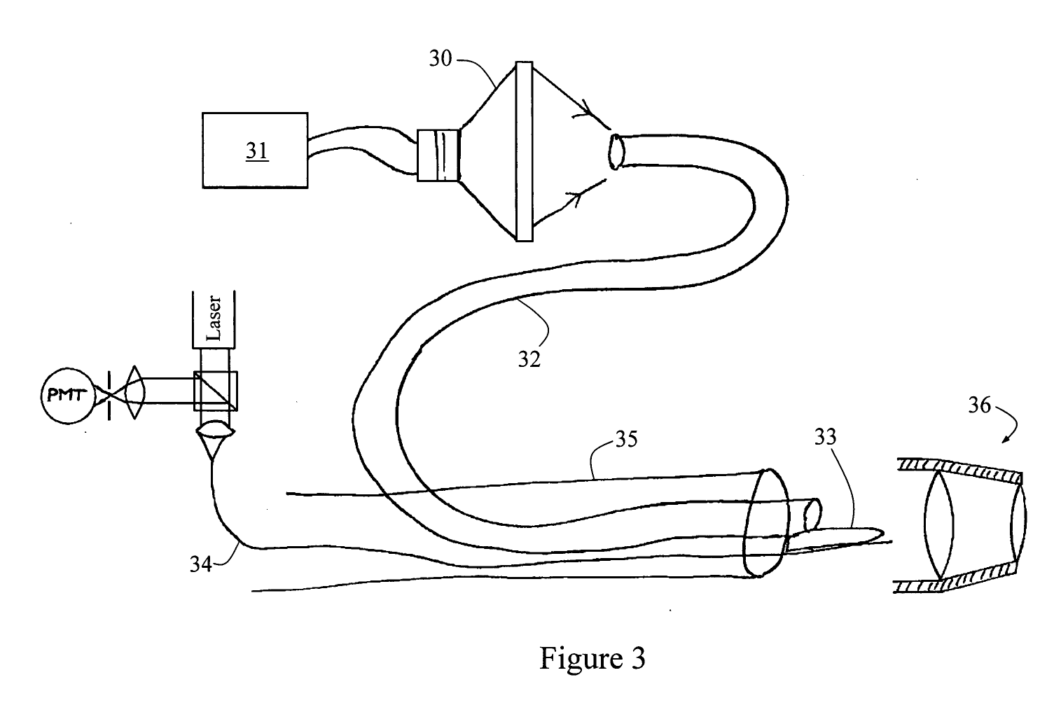

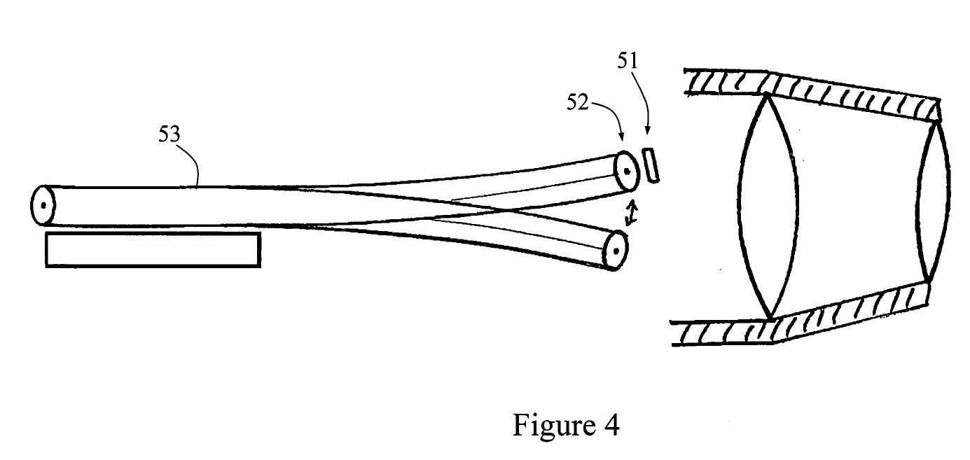

Two exemplary methods of providing positional feedback are as follows:
1) Referring to FIG. 4, a synchronizing pulse is generated in the return light by positioning a reflector 51 close to the tip 52 of the vibrating fiber 53. As the fiber 53 passes the reflector 51, a blip of light passes back along the fiber; its wavelength and intensity can easily be demodulated from the specimen signal and from noise. The reflector can either be a chip of plane mirror or a corner cube or cats eye reflector. It is preferably positioned towards one extreme of the excursion of the fiber movement. It is also preferably positioned on the arm that moves with the slow scan actuator.
2) Referring to FIG. 5, positional information can also be obtained by means of additional optical fibers 61 and 62, which are positioned so as to sample light from within a scanning head. The laser light 63, which is emitted from the scanning fiber 64, sweeps an arc within the sensor tip head and the intensity of the light on either side of the fiber swing will vary in synchrony with the movement of the fiber. The reflection signal may be derived from reflection from existing components 65 or special reflectors may be put in the tip chamber 66. It is desirable to employ a highly multi-moded fiber for this purpose (for example, 100 micron PCS fiber), in order to maximize the signal and to average out optical interference fluctuations.

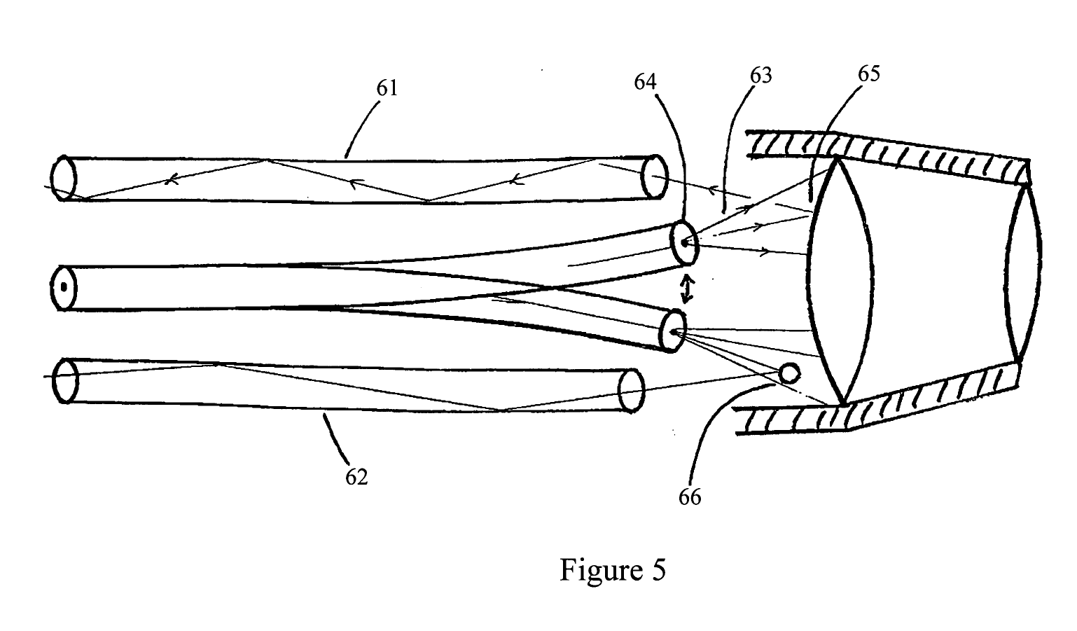

In FIG. 1B, an arm 13 is pivoted about point 14 by the combined effects of the inflation of polymer sack 16 and the resilient leaf spring 15. However, other mechanisms may be used to pivot this arm or its counterpart in other embodiments. For example, FIG. 6 is a schematic view of a reciprocating mechanism 70 for pivoting an arm in various embodiments of this inventions. The mechanism 70 is shown with a pivotable arm 72 that is mounted to pivot about pivot 74.

The reciprocating mechanism 70 comprises a pair of flexible polymer sacks 76a and 76b, locatable on opposite sides of arm 72, and a corresponding pair of piston/cylinder mechanisms 78a and 78b. Polymer sack 76a is in fluid communication with piston/cylinder mechanism 78a by means of conduit 80a, so that polymer sack 76a can be inflated by depression of the piston of piston/cylinder mechanism 78a. Similarly, polymer sack 76b is in fluid communication with piston/cylinder mechanism 78b by means of conduit 80b, so that polymer sack 76b can be inflated by depression of the piston of piston/cylinder mechanism 78b. The fluid in these components can be a liquid or a gas, but is in this embodiment a liquid so as to have a low compressibility. This facilitates a prompt response the piston/cylinder mechanisms 78a and 78b are depressed.

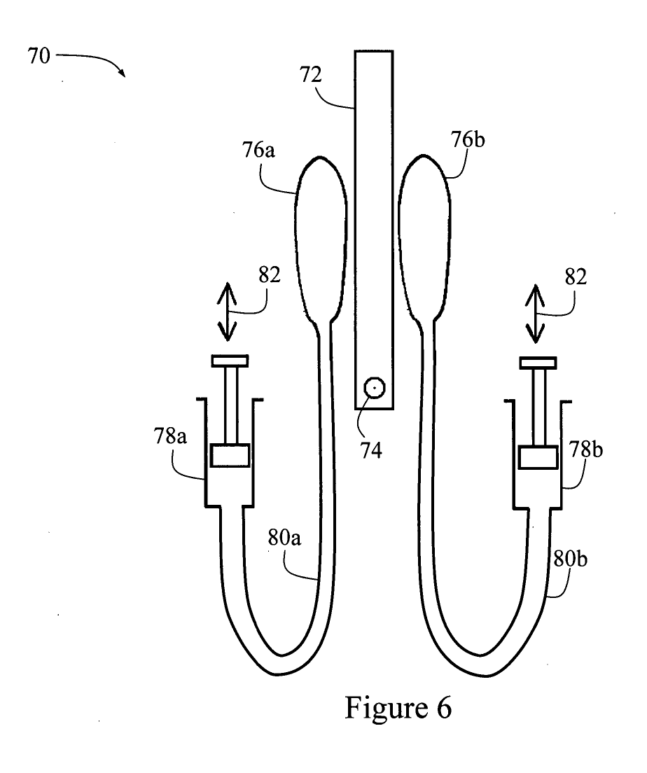

FIG. 7 is a schematic view of an alternative reciprocating mechanism 90 for pivoting an arm in various embodiments of this inventions. The mechanism 90 is shown with a pivotable arm 92 that is mounted to pivot about pivot 94.

Another reciprocating mechanism 90 comprises a pair of flexible polymer sacks 96a and 96b, locatable on opposite sides of arm 92, and a corresponding pair of piston/cylinder mechanisms 98a and 98b in fluid communication with, respectively, polymer sack 96a and polymer sack 96b. In this respect reciprocating mechanism 90 is comparable to reciprocating mechanism 70 of FIG. 6.

However, the pistons of the two piston/cylinder mechanisms are opposed relative to each other. The reciprocating mechanism 90 also includes a mechanically driven, reciprocating actuator 102 with an arm 104 located between these pistons. By driving the arm to swing in a reciprocating manner, the arm alternately depresses and then releases 106 first one and then the other piston. As a result, polymer sacks 96a and 96b are alternately inflated and deflated, and alternate in urging the arm 92—being located between the sacks—towards the other sack. Arm 92 is thus caused to reciprocate about pivot 94. Reciprocating actuator 102 can be driven by any suitable means, including an electric motor or a hydraulic pump.

It has been found that, advantageously, the sacks of the various embodiments described above (including sacks 16, 76a, 76b, 96a and 96b) can be made from heat-shrink. Heat-shrink of approximately 1.5 mm diameter (before being shrunk) can be clamped over a short section that will ultimately constitute the sack. The remainder of the heat-shrink is then heated and shrunk to a diameter of approximately 0.5 mm, thereby providing a conduit for connection to, for example, a piston/cylinder mechanism. The open end of the heat-shrink adjacent the sack can then be sealed by, for example, clamping or heat-sealing.

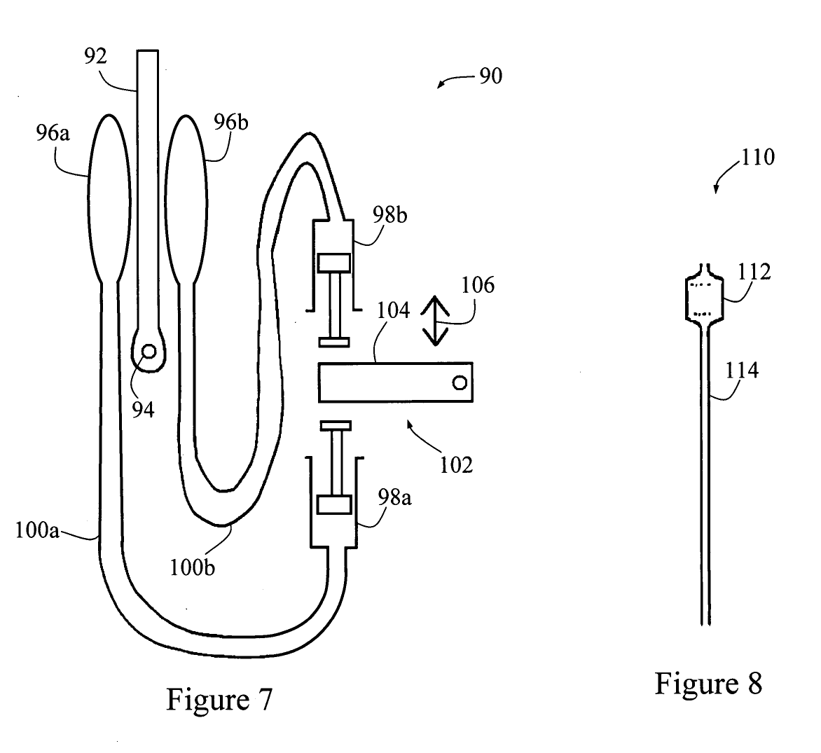

The FIG. 8 is a schematic view of a length of heat-shrink 110 after being treated in this manner. A sack 112 is formed and, as it has not been exposed to heat, retains essentially all the original flexibility of the heat-shrink material. The flexibility of the conduit 114 will generally be somewhat reduced, but adequate flexibility will remain to permit sufficient bending of the conduit during its installation in an optical apparatus.

Modifications within the scope of the invention may be readily effected by those skilled in the art. It is to be understood, therefore, that this invention is not limited to the particular embodiments described by way of example hereinabove.

In the following claims and in the preceding description of the invention, except where the context requires otherwise owing to express language or necessary implication, the word “comprise” or variations such as “comprises” or “comprising” is used in an inclusive sense, i.e. to specify the presence of the stated features but not to preclude the presence or addition of further features in various embodiments of the invention.

Further, any reference herein to prior art is not intended to imply that such prior art forms or formed a part of the common general knowledge.

1. A scanning mechanism for an optical probe having an optical head and an optical transmitter for transmitting light from a light source to said optical head, the scanning mechanism comprising:
a resilient member coupled to said optical transmitter;
a fluid supply for providing a fluid to said head; and
an exit path for said fluid from said head having a fluid entry;
wherein said resilient member is located at said fluid entry so that fluid flow into said fluid entry passes over a portion of said resilient member and creates a pressure difference across said resilient member such that said resilient member is urged into said fluid entry thereby reducing said fluid flow and reducing said pressure difference, whereby said resilient member and therefore said fiber can be induced to oscillate.

2. A scanning mechanism as claimed in claim 1, wherein said exit path comprises a conduit.

3. A scanning mechanism as claimed in claim 1, wherein said fluid supply comprises a fluid supply conduit.

4. A scanning mechanism as claimed in claim 1, wherein said fluid supply comprises a fluid reservoir.

5. A scanning mechanism as claimed in claim 1, wherein the fluid is air.

6. A scanning mechanism as claimed in claim 1, wherein said resilient member is adapted or operable to oscillate at a resonant frequency.

7. A scanning mechanism for an optical probe having an optical head and an optical transmitter for transmitting light from a light source to said optical head, the scanning mechanism comprising:
an inflatable reservoir coupled to said optical transmitter;
a fluid supply for providing a fluid to said reservoir; and
means for expelling said fluid from said reservoir;
wherein said reservoir is alternately inflated and deflated so that said optical transmitter is reciprocated.

8. A scanning mechanism as claimed in claim 7, wherein the means for expelling said fluid from said reservoir comprises said fluid supply when operated in reverse.

9. A scanning mechanism as claimed in claim 7, wherein the means for expelling said fluid comprises a spring for compressing an exterior surface of said reservoir.

10. A scanning mechanism as claimed in claim 7, wherein the means for expelling said fluid comprises a resilient material surrounding or constituting said reservoir.

11. A scanning mechanism for an optical probe having an optical head and an optical transmitter for transmitting light from a light source to said optical head, the scanning mechanism comprising:
a resilient member coupled to said optical transmitter; and
an actuator for providing pressure waves, coupled to said resilient member;
whereby said resilient member can be vibrated by said actuator so as to vibrate said optical transmitter.

12. A scanning mechanism as claimed in claim 11, further including a conduit coupled to said actuator for transmitting said pressure waves to said resilient member.

13. A scanning mechanism as claimed in claim 11, wherein said resilient member is adapted or operable to oscillate at a resonant frequency.

14. A scanning mechanism for an optical probe having an optical head and an optical transmitter for transmitting light from a light source to said optical head, the scanning mechanism comprising:
a resilient member coupled to said optical transmitter;
a fluid supply for providing a fluid to said head and having a fluid exit; and
an exit path for said fluid to exit said head;
wherein said resilient member is located at said fluid exit so that fluid flow out of said fluid exit passes over a portion of said resilient member and creates a pressure difference across said resilient member such that said resilient member is urged into said fluid exit thereby impeding said fluid flow and reducing said pressure difference, whereby said resilient member and therefore said fiber can be induced to oscillate.

15. A scanning mechanism as claimed in claim 14, wherein said fluid supply comprises a conduit.

16. A scanning mechanism as claimed in claim 14, wherein said resilient member is adapted or operable to oscillate at a resonant frequency.

17. A scanning method for an optical probe having an optical head and an optical transmitter for transmitting light from a light source to said optical head, the method comprising:
providing a fluid to said head;
providing for said fluid an exit path from said head, the exit path having an fluid entry;
coupling a resilient member located at said fluid entry to said optical transmitter; and
passing said fluid over a portion of said resilient member and thereby urging said resilient member into said fluid entry thereby reducing said fluid flow, reducing a pressure difference across said resilient member and causing said resilient member to oscillate.

18. A scanning method for an optical probe having an optical head and an optical transmitter for transmitting light from a light source to said optical head, the method comprising:
alternately inflating and deflating an inflatable reservoir coupled to said optical transmitter.

19. A method as claimed in claim 18, including inflating said reservoir by means of a fluid supply for providing a fluid to said reservoir.

20. A scanning method for an optical probe having an optical head and an optical transmitter for transmitting light from a light source to said optical head, the method comprising:
generating pressure waves; and
coupling said pressure waves and thereby vibrating a resilient member coupled to said optical transmitter.

21. A scanning method for an optical probe having an optical head and an optical transmitter for transmitting light from a light source to said optical head, the scanning mechanism comprising:
providing a fluid to said head at a fluid entry;
providing an exit path for said fluid from said head;
coupling a resilient member located at said fluid entry to said optical transmitter; and
passing said fluid over a portion of said resilient member and thereby urging said resilient member into said fluid entry thereby reducing said fluid flow, reducing a pressure difference across said resilient member and causing said resilient member to oscillate.
